(19) United States
(12) Patent Application Publication
(10) Pub. No.: US 2026/0228190 A1
(43) Pub. Date: Aug. 6, 2026

(54) SYSTEM AND METHOD FOR CLOUD-TO-CLOUD MIGRATION OF DATA

(71) Applicant: Flexify Inc., Tampa, FL (US)

(72) Inventors: Sergei Kandaurov, Puerto Princesa City (PH); Anna Pavnyk, Nizhnij Novgorod (RU)

(21) Appl. No.: 19/042,966

(22) Filed: Jan. 31, 2025

(51) Int. Cl. G06F 16/21

(52) U.S. Cl. CPC G06F 16/214

(57) ABSTRACT

A computer-implement system for migrating data from a first object storage service to a second object storage service. The system has at least one computing device having a processor. A management module operating on the processor is provided and configured to receive a migration request from a user and identify migration parameters based on data metrics collected from the first object storage service and the second object storage service. Additionally, a plurality of engines configured to receive tasks from the management module and migrate data from the first object storage service to the second object storage service, wherein each engine of the plurality of engines is assigned a migration slot by the management module on pseudo-random basis.

### BACKGROUND

The present invention generally relates to data storage. More specifically, the present invention relates to a system and method for cloud-to-cloud migration of large amounts of data between multiple data storage providers.

An organization's data is often one of the most valuable assets of an organization. Such data can include customer information, data analytics, valuable financial information, personal employee records, business and consumer-facing applications, and the like. The key value of the organization's data dictates that the decisions on how and where to maintain and store data is of the most importance for the organization.

Object storage systems that store data on-premises or remotely by using a cloud object storage provider where data is stored as objects have gained popularity over a more conventional file storage arrangement where all data is saved together in a single file system in a structure of folders or directories.

Object storage systems separate data into self-contained units (i.e., objects) that are all stored on the same “level.” That is, there are no folders or sub-directories like those used with a file storage. Additionally, the object storage system does not store all data together in a single file system.

Objects contain metadata, which is information about an object that helps with processing and usability. Users can set the value for fixed-key metadata with the object storage, or they can create both the key and value for custom metadata associated with an object. Instead of using a file name and path to access an object, each object has a unique identifier (i.e., a key).

Organizations often store their data (objects) on cloud servers provided by third-party cloud storage providers, such as Amazon Web Services, Microsoft Azure, Google Cloud Platform, IBM Cloud, Alibaba Cloud and others. Each of these services provides their unique Application Programming Interface (API) to access and manage objects stored on their systems.

The enormous amount of data being stored on the cloud storages and fierce competition amongst the cloud storage providers with respect to pricing and services, has allowed modern businesses to leverage a multi-cloud strategy and migration to reduce costs of storing large amount of data, provide for better security of its data, and provide for quicker access and control over their data.

However, cloud-to-cloud, on-premises-to-cloud, or cloud-to-on-premises migration of large amounts of data can be challenging. For example, it is not uncommon to maintain more than 1000 Terabytes of data by the organization, and such large amount of data can take weeks to migrate. The costs associated with migration (e.g., egress traffic chargers) charged by the service providers can make the migration cost prohibitive.

Due to fierce competition between the cloud storage service providers, the service providers have little or no incentive to make data migration readily available to the organizations, and often erect artificial barriers to migration between the cloud storages. Various legislations around the world have been enacted to give back control to the organizations and individuals over the storage of their data. In response, some service providers reduced or eliminated egress fees for data migration, but still make the egress non-monetary cost to the organization unnecessary high by, for example, requiring closing accounts where the data was stored or deleting the data, which is often unacceptable to organizations.

Moreover, each cloud storage provider generally has a unique API and product offerings, making the migration even more challenging.

A solution is therefore needed that will help organizations to realize their multi-cloud strategy by creating a system with a cloud-agnostic storage layer on top of multiple cloud or private storages and enabling flexible and inexpensive data migration and virtualization across multiple cloud or on-premises storage.

### SUMMARY

According to a non-limiting embodiment of the present invention, a computer-implement system for migrating data from a first object storage service to a second object storage service is provided. The system has at least one computing device having a processor, a management module operating on the processor configured to receive a migration request from a user and identify migration parameters based on data metrics collected from the first object storage service and the second object storage service, and a plurality of engines configured to receive tasks from the management module and migrate data from the first object storage service to the second object storage service. Each engine of the plurality of engines is assigned a migration slot by the management module allowing to split migration objects across engines on pseudo-random basis.

In another aspect of the present invention a computer-implemented method for migrating data from a first object storage service to a second object storage service is provided. The method is initiated by receiving a migration request by a management module from a user. Then, the method provides for identifying migration parameters based on data metrics collected from the first object storage service and the second object storage service and providing tasks to a plurality of engines by the management module to migrate data from the first object storage service to the second object storage service. The next step of the method is assigning each engine of the plurality of engines a migration slot by the management module. Finaly, the method provides for writing data objects in the second object storage service.

In yet another aspect of the present invention, a computer-implement system for migrating object data from a source object storage to a destination object storage is provided. The system according to this aspect can include a memory and one or more processors to execute computer-readable instructions stored in the memory to perform a method. The method can include receiving a migration request by a management module from a user, identifying migration parameters based on data metrics collected from the source object storage and the destination object storage, and receiving by a migration manager of the management module the tasks from a task manger. The next steps of the method are deploying the plurality of engines by an engine deployer based on the migration parameters and assigning the migration slot to each engine of the plurality of engines. Then, the method provides for receiving the migration status reports by a report processor from the plurality of engines and providing status reports to the task manager and receiving tasks requests by a task describer from the plurality of engines, identifying tasks parameters and providing the tasks descriptions to each engine. Each engine can be listing objects by a first lister from the first object storage service and listing objects by a second lister from the second object storage service, reading the objects by a migrator from the source object storage and writing the objects in the destination object storage, comparing by a comparator the objects from the source object storage and the objects in the destination object storage to verify whether the object to be migrated to the destination object storage and feeding the lists of objects to be migrated to the migrator, wherein the comparator compares the objects page-by-page; and, finally, writing data objects in the destination object storage.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a diagram of a computer-implemented system for data migration from one cloud provider to another cloud provider or across various cloud providers in accordance with embodiments of this invention;

FIG. 2 depicts a diagram of an exemplary embodiment configured to pseudo-randomly distributing data across multiple engines in accordance with embodiments of this invention;

FIG. 3 depicts a diagram illustrating the command and reporting processes between the management module and the engines in accordance with embodiments of this invention;

FIG. 4 depicts a diagram illustrating an exemplary configuration of the management module in accordance with embodiments of this invention;

FIG. 5 depicts a diagram of an exemplary embodiment of an engine in accordance with embodiments of this invention;

FIG. 6 depicts a diagram illustrating yet another exemplary embodiment of engine in accordance with embodiments of this invention;

FIG. 7 depicts a diagram illustrating an exemplary configuration of a frontend abstraction in accordance with embodiments of this invention;

FIG. 8 depicts a diagram illustrating an exemplary configuration of forwarding and migration cores of the engine in accordance with embodiments of this invention; and

FIG. 9 depicts a flow diagram illustrating method for data migration from a source cloud to a destination cloud using the computer-implemented system in accordance with embodiments of this invention.

In the accompanying figures and following detailed description of the described embodiments, the various elements illustrated in the figures are provided with two, three or four digit reference numbers. With minor exceptions, the leftmost digit(s) of each reference number correspond to the figure in which its element is first illustrated.

### DETAILED DESCRIPTION

Reference to “a specific embodiment” or a similar expression in the specification means that specific features, structures, or characteristics described in the specific embodiments are included in at least one specific embodiment of the present invention. Hence, the wording “in a specific embodiment” or a similar expression in this specification does not necessarily refer to the same specific embodiment.

Hereinafter, various embodiments of the present invention will be described in more detail with reference to the accompanying drawings. Nevertheless, it should be understood that the present invention could be modified by those skilled in the art in accordance with the following description to achieve the results of the present invention. Therefore, the following description should be considered as a pervasive and explanatory description related to the present invention for those skilled in the art, not intended to limit the claims of the present invention.

Reference to “an embodiment,” “a certain embodiment” or a similar expression in the specification means that related features, structures, or characteristics described in the embodiment are included in at least one embodiment of the present invention. Hence, the wording “in an embodiment,” “in a certain embodiment” or a similar expression in this specification does not necessarily refer to the same specific embodiment.

A cloud-native object storage is specifically designed for scalability, making it a perfect choice for data-driven organizations. Embodiments of the present invention are directed to a system for a cloud-to-cloud migration of large amounts of data between multiple data cloud storage providers.

Generally, object storage systems separate data into self-contained units that are stored in with all objects being on the same “level.” Objects contain metadata, which is essentially information about the object that helps with processing and usability of the data. Users can set the value for fixed-key metadata with object storage, or can create both the key and value for custom metadata associated with an object.

Cloud object storage allows organization's applications access the stored data via application programming protocols (APIs) simultaneously. It is not uncommon to store thousands of terabytes of data for a single organization. Such large amounts of data require the organization to make important decisions with respect to storing, handling, securing and maintaining the data. To that end, many modern organizations develop multi-cloud strategies for storing and migrating their data.

There are various cloud storage providers, for example, Amazon Web Services (AWS), Microsoft Azure, Google Cloud Platform (GCP), IBM Cloud, Alibaba Cloud and others that offer cloud storage and migration services. While having access to a broad range of cloud storage providers help the organizations to execute their multi-cloud strategies, storing, accessing and migrating data across different cloud providers create a number of technical, business and financial challenges for the organizations.

For example, traditional cloud-to-cloud migration of large amounts of data can be cost-prohibitive, disruptive to the organization, time-consuming and inherently unreliable. The data can be lost or disrupted during the migration process rendering the organization applications inoperable upon completion of the migration. In some instances, some or all of the data can be inaccessible during the migration, which can cause damage to the business of the organization, especially when the data stored is very large or represent a core data for the organization.

In addition, while cloud providers, offer a range of tools and services, including their unique API, there is a risk of vendor “lock-in.” In other words, when an organization becomes dependent on a single cloud provider and finds it difficult and costly to switch providers because a migration to another cloud provider is cost-prohibitive, requires applications' updates and/or code re-write, overly disruptive to the business, and risky due to data corruption during the migration.

In order to address the forgoing shortcomings, embodiments of the present invention provide a decentralized system that allows for large scale cloud-to cloud migrations of petabytes of data containing billions of objects. This scale requires the system of the present invention to work with any data size and any number of objects to be migrated, essentially without a limit, not being limited to a single “worker”/“engine” machine, i.e., the migration being distributed across multiple engines, not requiring a central coordinator during the migration, and not requiring “worker”/“engine” to be in communication with each other during the migration.

The system of the present invention allows for migrating data between the various cloud storages providers, migrating data from the on-premise storage to cloud storage or from the cloud storage to on-premise storage, combining multiple cloud or on-premise storages in a single virtual storage, and storing data in multiple cloud or on-premise storages simultaneously.

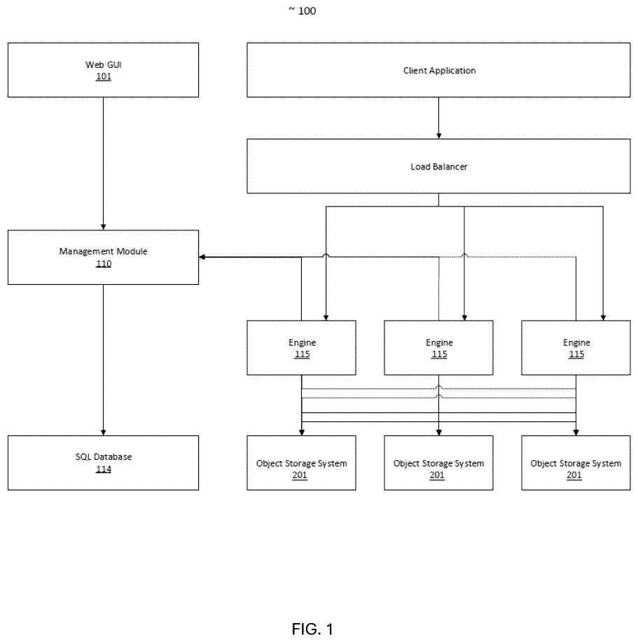

In order to achieve the forgoing tasks, the system of the present invention is a computer-implemented system that has a processor and a memory configured to store one or more sequences of instructions which, when executed by the processor, cause the processor to carry out the steps and methods illustrated in FIGS. 1-9.

FIG. 1 shows a block diagram of a computer-implemented system 100 that provides for a method and system for data migration from one cloud provider to another cloud provider, from an on-premise object storage to a cloud provider, or from a cloud provider to on-premise object storage.

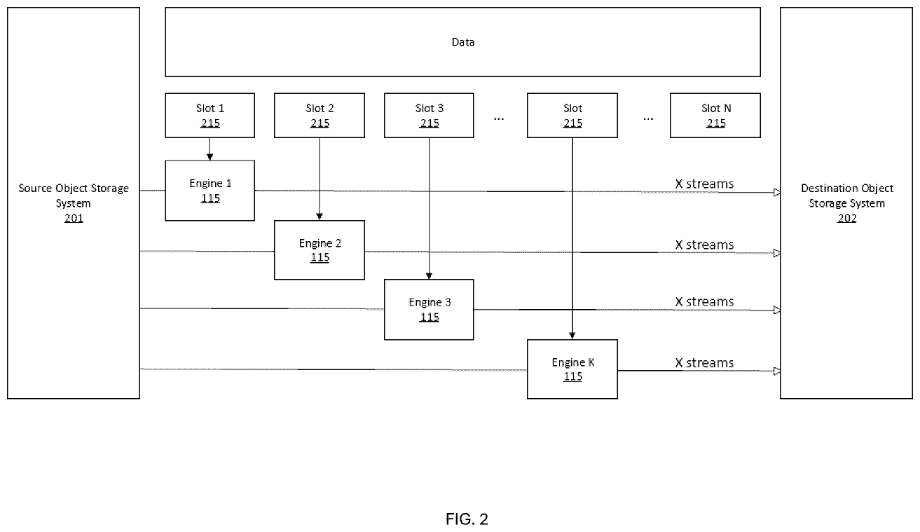

A user may wish to migrate their data from a first object storage to a second object storage, different from the first object storage or to multiple object storages, either provided by cloud providers or on-premises. The first object storage system or service is referred to as a source 201 (shown in FIG. 1), for example, Amazon Web Services (AWS). The second object storage system or service is referred to as a destination 202 (shown in FIG. 2), for example, Google Cloud Storage. Migration process is completed when all the data and the metadata is migrated from the source 201 to the destination 202.

The migration is performed via networks online and can be non-disruptive to user's applications. The applications can continue to read and write data to an object storage, while the data is being migrated from the source 201 to the destination 202 in the background.

Embodiments of the present invention can combine all data from a multiple of object storages, while allowing the applications and users to view and access all objects from all storages at any time during migration or permanently, and in real-time.

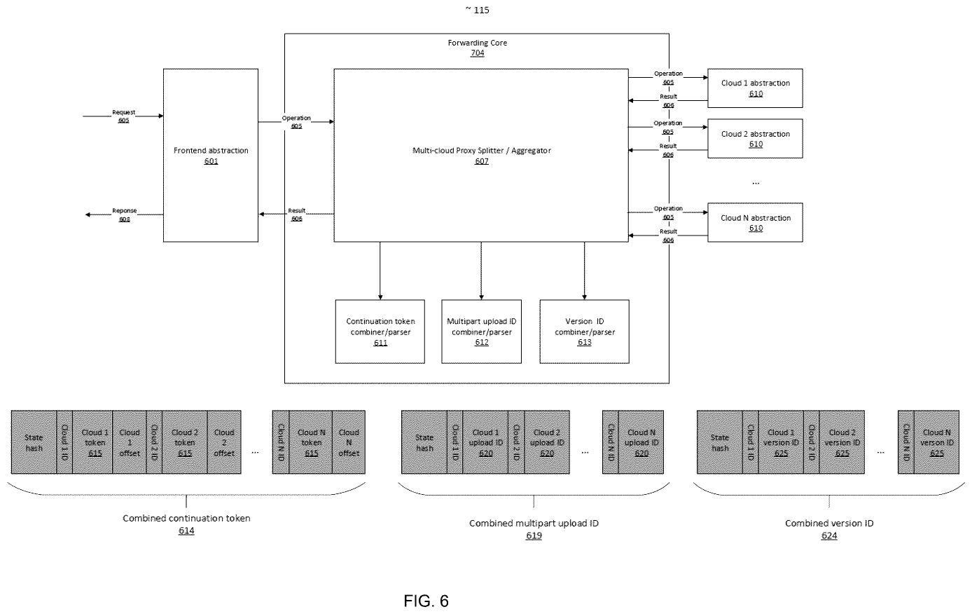

Further, embodiments of the present invention can translate standard (S3) requests into the cloud storage APIs, for example, to Microsoft Azure or Alibaba Cloud APIs, thereby allowing the applications to work with any cloud via the standard S3 API, or with all clouds (as shown in FIGS. 6-8).

FIGS. 1 and 2 illustrate an exemplary embodiment of a system 100 that provides a management module 110. The management module 110 receives a migration request from a user 101 via, for example, a web graphic user interface (GUI). The user 101 can communicate the migration request through HTTP requests via, for example, representational state transfer (REST) application programming interface (API), as shown in FIG. 1.

The management module 110 identifies and collects from the source 201 and destination 202 the respective data metrics and dimensions that can be stored in, for example SQL database 114 or other similar tools for configuring and monitoring data. The management module 110 can identify and/or engines 115 can identify storages-related information, such as lists of buckets or containers, their regions, and the amount of data in bytes that is stored in the storages 201, 202 (the amount of data is determined by the engines 115). This value can be then calculated by summing the size of all objects and metadata in the bucket (both current and noncurrent object versions), including the size of all parts for all incomplete multipart uploads in the bucket. The total number of objects stored in storages 201, 202 can be then calculated. This value can be calculated by counting all objects in the bucket, can include current and noncurrent object versions, delete markers, and the total number and size of incomplete multipart uploads to the bucket. Additionally, the management module 110 can collect statistics about objects' storage class (size and number for each storage class separately), distribute by size and estimate equally distanced keys by both objects size and number.

For example, the following metrics can be collected: the total objects number, total size of objects in the storages; size and number for each storage class; distribution by size (number and total size); equally distanced keys (by number and by size); and buckets regions.

In addition, the management module 110 can identify the total number of HTTP requests made to the storages 201, 202, regardless of type. More specially, the number of HTTP GET requests made for objects. The number of HTTP PUT requests made for objects. The number of HTTP DELETE requests made for objects. The number of HTTP POST requests. The number of bytes of data sent in requests. The number of bytes of data returned with requests. The number of HTTP requests that list the contents. The number of bytes uploaded for requests made, where the request includes a body. The elapsed per-request time from the first byte received to the last byte sent. The per-request time from the complete request being received to when the response starts to be returned.

Based on the metrics and dimensions, the management module 110 identifies the cloud and region to start the engines 115 and the total number of the engines 115 required for the migration. According to embodiments of the present invention, the engines 115 can be virtual machines (VMs) or containers on-premises or in the cloud environment, e.g., Amazon Elastic Compute Cloud (Amazon EC2) instances, running the migration. This configuration allows for greater horizonal scalability as shown in FIG. 2.

As illustrated in FIG. 2, the system 100 is configured to pseudo-randomly distributing data migration across multiple engines 115 using modulus of object's metadata hash value. More specifically, when data is migrated from the source 201 to the destination 202, migrations are distributed across multiple engines 115 so there is no requirement for central coordination of the migrations nor a need for the engines 115 to communicate with each other during the migration process. This is achieved by the management module 110 that selects a number of slots 215 according to the following formula:

$$N \geq K$$

where N is a number of slots 215 and K is a number of engines 115. The management module 110 determines the number of streams X based on the statistics for migration source and destination initially determined and estimated ratio between the total size of the objects and the number of objects stored in the source 201.

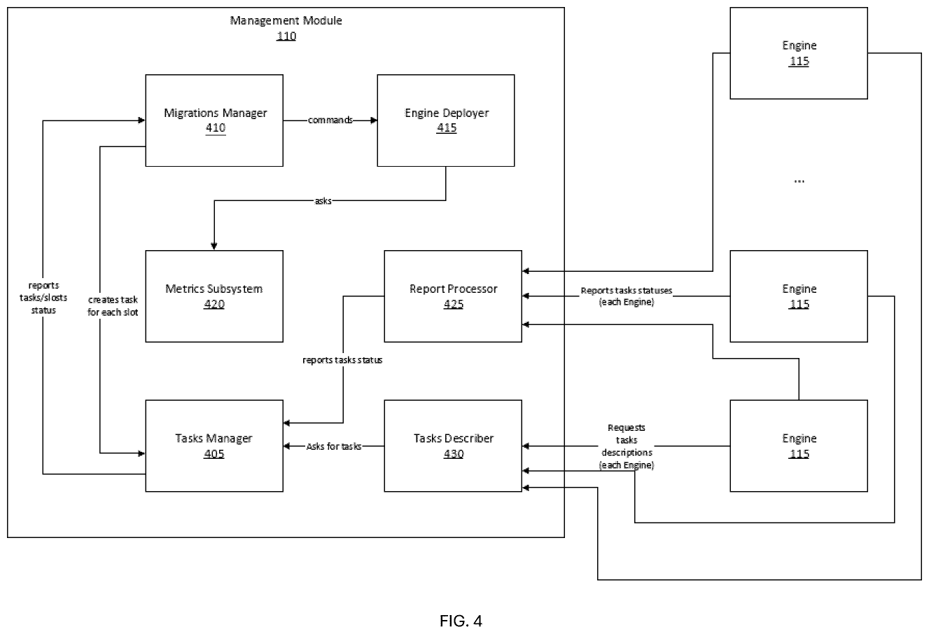

The management module 110 via a task manger 405 (shown in FIG. 4) assigns tasks to the engines 115, providing among other parameters 112, for example, migration source, destination, previously selected X, N, and the unique (within this migration) slot number E that is smaller than the number of slots 215 (0<=E<N), as shown in FIG. 2. The engines 115 can run migration independently of each other and the management module 110.

Each engine 115 can independently list all of the objects' keys/names stored in the source 201, and for each object, calculates hash (object_key) % number of slots 215 N. For example, the engine 115 can use first four bytes of message-digest algorithm MD5 converted to a 32-bit unsigned integer (UINT32) as a hash function. In other words, for each object, the engine 115 calculates hash(object_key) % N (a remainder that denotes modulo operation, i.e., a reminder after division) and compares it to E. If this calculation equals assigned slot number E the engine 115 takes the object for processing. Otherwise, the engine 115 skips the object. As the result, the objects are distributed pseudo-randomly (and nearly equally) across all slots 215 and consequently across all engines 115. In addition, the slot_seed number can be randomly selected for each migration, and remain the same for all engines 115 involved in this specific migration execution. Another migration execution between the same source/destination will have different slot_seed. In this instance, the engines 115 calculate hash(object_key, slot_seed) instead of hash(object_key). As the result, objects distribution between engines 115 will be different. This allows to compensate for effects when some (but not all) of migration slots fail and a new migration between the same source/destination is started. Without different slot_seeds, some of the engines 115 will be processing objects that are already migrated, and some that are not yet migrated.

When the number of engines 115 is less than a number of slots 215 (K<N), the engines 115 that finish processing the assigned tasks are assigned to a new task with new unique (not yet used) E.

When tasks with each E from 0 to N−1 are finished, each object from the list was processed by exactly one of the engines 115. This means that all data had been processed and migrated to the destination 202.

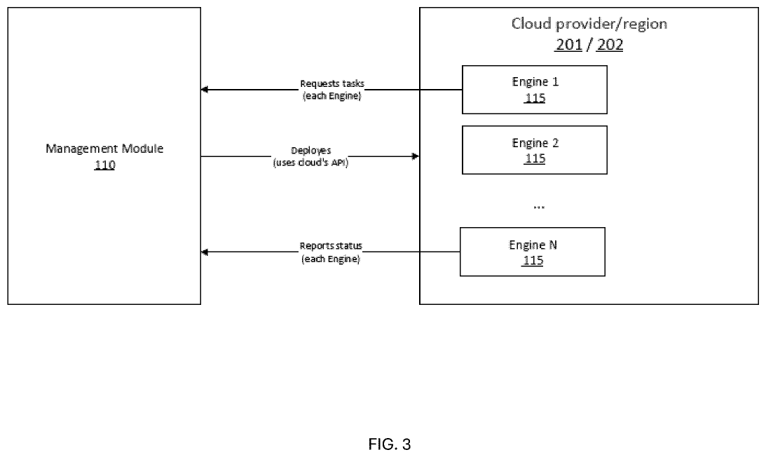

FIG. 3 illustrates the command and reporting processes between the management module 110 and the engines 115. The management module 110 via an engine deployer (not shown) and using the selected cloud's API deploys a selected number of engines 115 based on the parameters 112 (as also shown in FIG. 1). During the migration process, the management module 110 can assign additional tasks to engine, for example when migration task with E=1 completes, a migration task with E=2 can be assigned. The engines 115 request the list of new tasks by polling every S seconds, for example every 5 seconds.

In addition, according to embodiments of the present invention, the engines 115 provide status report to a report processor 425 (shown in FIG. 4) of the management module 110 within predetermined time intervals, e.g., five-second intervals. The report processor processes the reports and feeds the information collected to the task manager 405 (shown in FIG. 4) These status reports can provide information about the tasks completed by the specific engine 115, such as upload/download status.

FIG. 4 illustrates configuration of the management module 110 according to embodiment of the present invention. The management module 110 has a migration manager 410 that receives instructions from the task manager 405 that manages and monitors the migration process. The instruction can be tasks initiating the migration, such as requests to look up the parameters 112, including table of metrics stored in the SQL database for the source 201 and the destination 202, which can include source and destination storage provider ID, source and destination regions, partner ID, price list ID, number of streams, cloud and region for the engines 115, and the number of engines 115 to use or deploy. From the table of metrics, the task manager 405 can determine the specific cloud and region to start the engines 115, the number of engines 115 needed, and select the number of slots 215. Generally, the location of source data controls the selection of the cloud and region to deploy the engines 115. The task manager 405 can also request status reports (as described above).

The migration manager 410 then directs the engines 115 deployment via an engine deployer 415. Alternatively, existing/pre-deployed engines 115 can be used. The engine deployer 415 receives from the migration manager 410 the information about clouds, regions, the number of engines 115 necessary for migration. Then, the engine deployer 415 uses corresponding cloud's API to start the required number of virtual machines or containers and configures them as engines 115.

The management module 110 can also have a report processor 425 that receives the migration status reports from the engines 115 and provides the status reports to the task manager 405. In addition, the management module 110 can include a task describer 430 that receives the task requests from the engines 115, then details the tasks parameters from the task manager 405, and sends the task descriptions back to engines 115. The task descriptions can include information about source and destination storages, comparison and conflict resolution methods, upload timestamp type and timestamp value, archive retrieval configuration, size limits, slot base and seed, and other information pertinent to the migration.

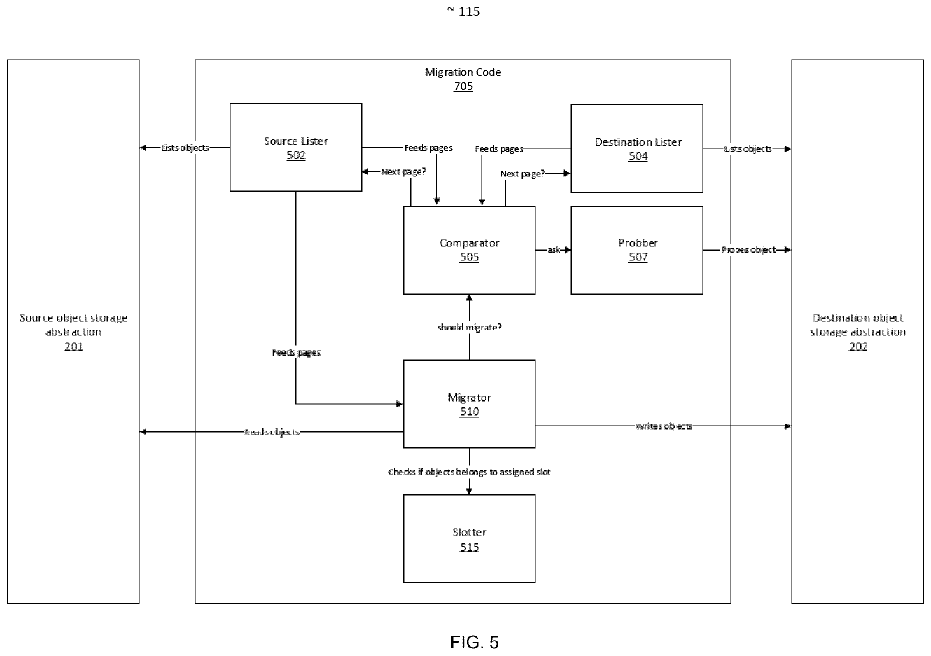

FIG. 5 illustrates an exemplary embodiment of the engine 115, which is primary responsible for migration process. According to embodiments of the represent invention, the engine 115 has a source lister 502 and a destination lister 504. The source lister 502 lists the objects, page by page from the source 201 (shown on FIG. 2) and the destination lister 504 lists, page by page, the objects from the destination 202 (shown on FIG. 2). The source lister 502 and the destination lister 504 provide the respective lists to a comparator 505. In certain embodiments, the engine 115 can have a single lister 502 that lists objects from source 201. The objects from the destination 202 are not listed by the lister 504, but rather probed by a prober 507 (shown in FIG. 5). This configuration is advantageous when sorting order is different between source/destination clouds or when migrating relatively small number of objects to the destination 202 that already contains a larger number of objects.

The comparator 505 compares the objects from the source 201 and the objects from the destination 202 to verify based on, for example, modification date and hashes, whether the specific object to be migrated to the destination 202 and feeds that lists of objects to be migrated to a migrator 510.

Because the number of objects stored on the clouds is so great, it is impossible to compare all the objects simultaneously. Accordingly, the comparator 505 compares the objects page by page. For example, each page having 1,000 objects. Once one page from the source lister 502 or destination lister 504 has been processed, using a continuation token from that page, the next page with another set of objects is fed to the comparator 505. However, in some instances, the sort order of the objects can vary in the source 201 from the destination 202 depending, for example, on which storage provider is used. In this instance, it can be impossible to compare the objects page by page. Accordingly, the engine 115 can also be provided with the prober 507. The comparator 505 is configured to identify non-standard sort orders of the objects (e.g., not following Amazon S3 rules) in source 201 and/or destination 202 and invoke the use of the prober 507. That is, when it is not possible to compare some objects page by page, the prober 507 verifies each such object individually by using object's key. This process allows the incremental and synchronized migration to the destination 202.

Further, as illustrated in FIG. 5, the engine 115 is provided with the migrator 510. The migrator 510 is configured to read objects from the source 201 and write the objects in the destination 202. However, as explained above, the migrator 510 does not read and write all of the available objects, but only those that have been selected by the comparator 505, and that are not yet available in the destination 202. Additionally, there can be other criteria that are used to select the objects to be migrated, for example, modification date or time, key pattern, and other user-defined criteria.

If there is a conflict between the object that is already stored in the destination 202 and the object to be written in the destination 202, then the system 100 is configured to resolve the conflict based on the set of resolution policies communicated to the engine 115 as part of task definition through the task manger 405 (shown in FIG. 4). For example, if the stored object has prior modification date than the object about to be written, the object with the newest date will be stored in the destination 202 or the object with a newer modification date can be stored alongside with the object with the older modification date. Additionally, the system is configured to compare hashes of the objects in order to verify if the object stored in the destination 202 has the same content as the object about to be written, and skip copying the object.

The engine 115 can also include a slotter 515 that receives configuration from the management module 110, such as the assigned slot 215 and allows distribute objects between the engines 115 to horizontally increase the speed of the migration. According to embodiment, the slotter 515 determines if a particular object must be migrated by this particular engine by using the following formula:

hash(key, slot_seed)% slot_base==slot.

If the slotter 515 determines that the particular object must be migrated in another slot, potentially by another engine, the slotter 515 simply allows it to be skipped in the current slot. On the other hand, if the slotter 515 determines that the object belongs to this assigned slot 215, migrator 510 requests from the comparator 505 verification whether the object should be migrated to the destination 202 or the object needs to be re-written or otherwise modified. And, if comparator 505 confirms that the object does not exist or needs to be re-written in the destination 202, the migrator migrates the object in the destination 202.

In certain instances, the user may wish to store data in various cloud storages simultaneously or divide data between various storage service providers. For example, the user may wish to store a portion of the data on Amazon Web Services and another portion of the data on Microsoft Azure, Google Cloud Platform, IBM Cloud, or Alibaba Cloud. To achieve a certain level of ease of accessing and interacting with the data stored in various different types of storages provided by multiple storage providers, the user generally prefers to use the same API (for example, Amazon S3 API) to interact and access the data in different storages.

As illustrated in FIG. 6, according to embodiments of the present invention, the engine 115 can be configured to offer the users ability to distribute and collect data from various types of storages (e.g., on-premise, Amazon Web Services, Microsoft Azure, Google Cloud Platform, IBM Cloud, or Alibaba Cloud) into a single virtual object storage that provides access to the data, stored with various storage systems or providers in the single namespace and using a single API, for example, S3.

As shown in FIG. 6, once a frontend abstraction 601 receives a request from the user, for example, a request to provide a list of objects, to get or put objects, and the like, the frontend abstraction 601 converts the request to an operation 605 that is provided to a multi-cloud proxy splitter/aggregator 607. The multi-cloud proxy splitter/aggregator 607 is configured to aggregate data, split data or carry out other functionalities depending on the request. The multi-cloud proxy splitter/aggregator 607 can send an operation 605 to various clouds abstractions 610 of different types of storages, such as on-premises object storage, Amazon Web Services, Microsoft Azure, Google Cloud Platform, IBM Cloud, or Alibaba Cloud. The multi-cloud proxy splitter/aggregator 607 then receives one or more results 606 from cloud abstraction(s) and delivers the combined result 606 to the frontend abstraction 601. The frontend abstraction 601 converts the result into the format of the original request, for example, S3, and delivers it to the user.

According to embodiment of the present invention and to allow for distribution and collection of data from various types of storages, the engine 115 is designed to operate in a stateless configuration. In other words, the engine 115 in order to process a request does not need to maintain information regarding previous requests. The engine 115 is configured to process the request based on the information contained in the request rather than seeking additional information from previous or other requests.

More specifically, when interacting with S3-compatible object storage, most of the processes require multiple requests to carry out a single process. For example, in order to request a list of all objects or object versions maintained on S3-compatible service, it is necessary to first request a first page that would contain 1000 objects and a token. The token is then used together with a second request to obtain the second page that would contain another 1000 objects and another token for the next request, and so on.

If user requires to upload a large object (e.g., five gigabytes or more), a single request to upload the object will not be the most efficient way to upload such a large amount of data because upload of such large amount of data takes significant time and if the connection is severed during the upload, the upload would need to restart and the upload must begin from the starting point. To alleviate this problem, according to embodiment of the present invention, a multi-part upload is used to upload a large object.

As illustrated in FIG. 6, the multi-part upload process requires several operations. First, the request to initiate the multi-part upload is sent to the storage provider, for example, Amazon S3 and Azure. In response, each storage provider returns a unique upload ID 620. In the next step, the object to be uploaded is divided (split) into smaller portions, for example, 100 megabytes each, by an API client (not shown). Then each portion of the object is uploaded by a separate operation and using the same upload ID 620. Once all the portions of the object are uploaded, using the same upload ID 620, a storage system or provider combines the separate portions again into a single data object.

As also illustrated in FIG. 6, the system 100 allows the user to store and/or upload data in multiple cloud storages 610 simultaneously. To achieve the multi-cloud storage configuration as different cloud storages 610 can have their own unique tokens or IDs, combiners/parsers 611, 612, 613 are configured to combine multiple tokens or IDs from different cloud providers into a single token or ID.

More specifically, when listing the objects or object versions, the continuation token combiner/parser 611 calculates a combined continuation token 614 that can have a specific cloud ID (e.g. cloud 1 ID), cloud 1 continuation token 615, and page offset, encoded in a format similar to BASE64 format. The combined continuation token 614 can encompass information from as many object storages 610 as requested by the user, as shown in FIG. 6. The state hash can be used to detect whether the configuration of the cloud storages has changed, for example another cloud storage was added, the state hash work to prevent the loss of data integrity. This combined continuation token 614 is included in the response to the user, and then used in the next request. If the next request is received by another engine 115, once the engine 115 parses the combined token 614, the engine 115 can recognize with what storage-specific continuation token and from what specific offset it should begin listing the objects in each object storage 610.

Similar process can be applied to a multipart upload process. When multipart upload is initiated, each cloud provider 610 returns a unique upload ID 620. The multipart upload ID combiner/parser 612 uses upload IDs 620 from more than one cloud storages 610 to create combined multipart upload ID 619 that is returned to the client in the response 608. Consequently, same or another engine 115 can receive a request 605 with the same combined upload ID 619, parse the combined upload ID 619 and recognize applicable individual upload IDs for the specific cloud storage 610, thereby allowing the engine 115 remain stateless and facilitate horizontal scaling of the uploads. Similar process can also be applied to object version IDs 625. The version ID combiner/parser 614 use object version IDs from more than one cloud storage 610 to create a combined version ID 624. When the engine 115 parses the combined version ID 624 it can recognize applicable individual version IDs for each specific cloud storage 610, thereby allowing the engine 115 remain stateless in operations with object versions.

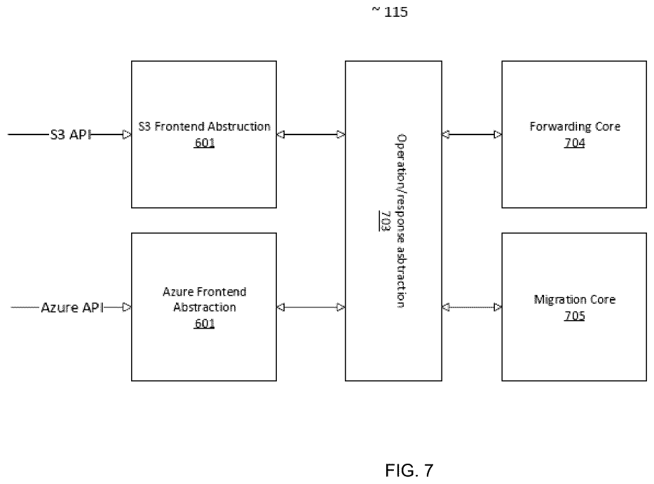

FIG. 7 illustrates the details of the frontend abstraction 601. According to embodiments of the present invention, the frontend abstraction 601 can have multiple cloud storages APIs, for example Amazon S3 and Microsoft Blob API. The frontend abstraction 601 essentially converts the native API format of cloud storages 201 into an internal notation operations/responses abstraction 703, and communicates operation commands and response to and from a forwarding core 704 of the engine 115.

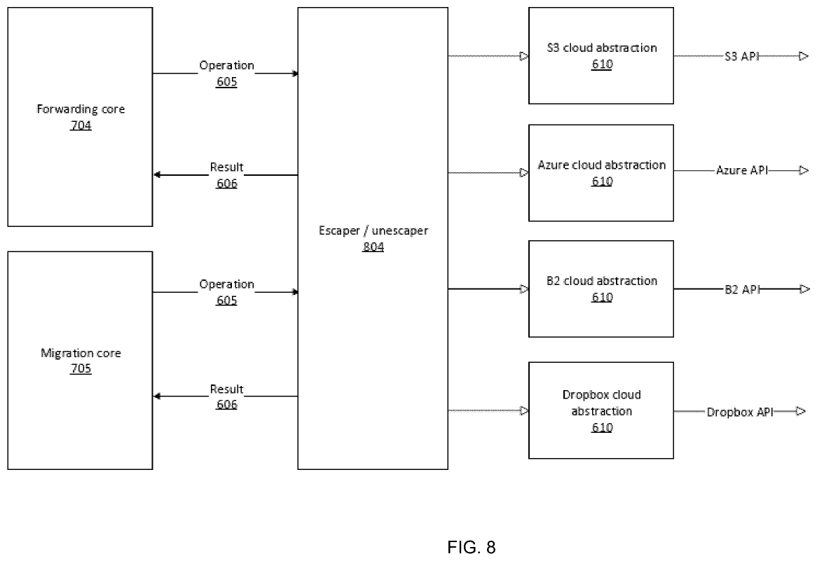

FIG. 8 illustrates the forwarding and migration cores of the engine 115. The engine 115 can include an escaper/unescaper 804, which is configured to align various specific formats of the different cloud providers by substituting unacceptable symbols and/or field names with an escape sequence that would be acceptable to the clouds when reading or writing the objects. For example, S3 API allows dashes “-” in metadata field names, which are not accepted by Azure. The escaper/unescaper 804 converts the dashes “-” into three underlines “_ _ _”. This process can be reversed by an unescaper functionality of the escaper/unescaper 804.

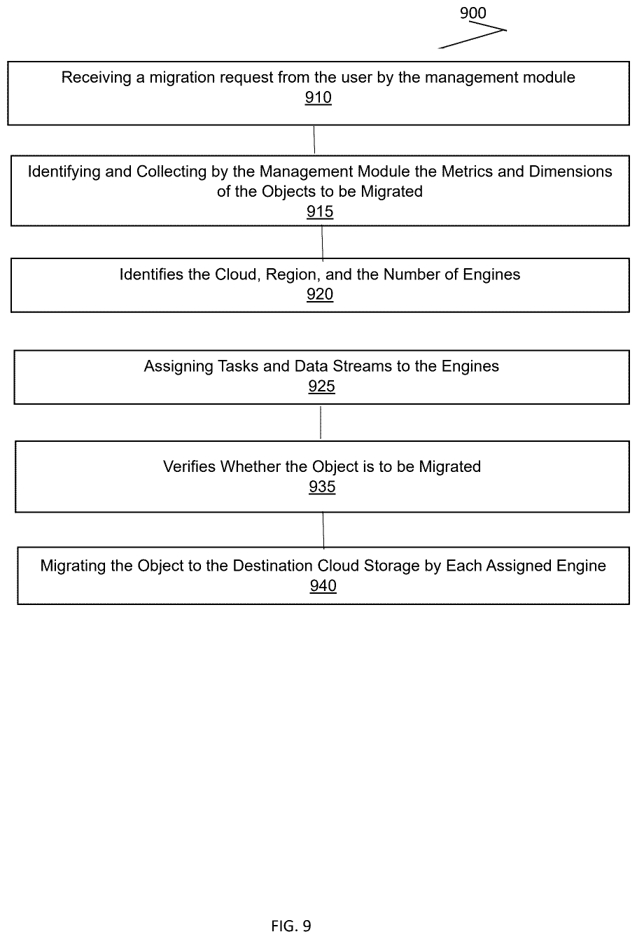

FIG. 9 is a flow diagram illustrating method 900 for data migration from the source 201 to the destination 202 using the computer-implemented system 100. A block 910 of the method 900 illustrates receiving a migration request from the user 101 by the management module 110.

In a block 915, the management module 110 identifies and collects from the source 201 and destination 202 the respective metrics and dimensions of the objects to be migrated (in case of the source 201).

In a block 920, the management module 110 identifies the cloud and region where to start the engines 115, and the number of the engines 115 that would be required for the migration.

In a block 925, the management module 110 through the task manger 405 assigns tasks to the engines 115 and the slots 215 based on the parameters 112, metrics of migration source 201 and destination 202.

In a block 935, the comparator 505 of the engine 115 verifies whether the object should be migrated to the destination 202 or skipped.

In a block 940, unless the comparator 505 confirms that the object already exists in the destination 202 or otherwise needs to be skipped, each engine 115 writes (migrates) the object to the destination 202 by employing the migrator 510.

The foregoing description for each embodiment is not intended to limit the scope of the present invention. All kinds of modifications made to the foregoing embodiments and equivalent arrangements should fall within the protected scope of the present invention. Hence, the scope of the present invention should be explained most widely according to the claims described thereafter in connection with the detailed description, and should cover all the possibly equivalent variations and equivalent arrangements.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer-implement system for migrating data from a first object storage service to a second object storage service, the system comprising:
at least one computing device having a processor;
a management module operating on the processor configured to receive a migration request from a user and identify migration parameters based on data metrics collected from the first object storage service and the second object storage service; and
a plurality of engines configured to receive tasks from the management module and migrate data from the first object storage service to the second object storage service,
wherein the management module is further configured to determine a number of migration slots, assign a unique migration slot identifier to each engine of the plurality of engines, and deploy the plurality of engines based on the migration parameters,
wherein each engine is configured to independently list objects stored in the first object storage service, calculate, for each listed object, a hash value of an object key, determine whether the object belongs to the assigned migration slot based on a modulo operation using the hash value and the number of migration slots, and migrate only objects assigned to the migration slot from the first object storage service to the second object storage service, and
wherein migration objects are distributed across the plurality of engines on a pseudo-random basis without requiring inter-engine communication during migration.

2. The system according to claim 1, wherein the first object storage service and/or the second object storage service are cloud-native object storage services.

3. The system according to claim 1, wherein the management module comprises:
a migration manger that creates the tasks in tasks manger and is configured to deploy the plurality of engines via an engine deployer based on the migration parameters, the migration parameters comprise at least one of a source storage region, a destination storage region, a total number of objects, a total size of objects, a number of migration streams, and a number of migration slots;
a report processor configured to receive the migration status reports from the plurality of engines and provide status reports to the task manager; and
a task describer configured to retrieve tasks requests from the plurality of engines, identify tasks parameters via the tasks manger and return the task descriptions to each engine.

4. The system according to claim 1, wherein each engine of the plurality of engines comprises:
a first lister that lists objects from the first object storage service and a second lister that lists the objects from the second object storage service;
a migrator configured to read the objects from the first object storage service and write the objects in the second object storage service;
a comparator configured to compare the objects from the first object storage service and the second object storage service to verify whether the object is to be migrated to the second object storage service and feed lists of objects to be migrated to the migrator, wherein the comparator compares the objects page-by-page; and
a slotter configured to receive the migration parameters from the management module, calculate a slot assignment for an object using a hash of an object key and a modulo operation, and verify whether the object is assigned to the migration slot of the engine of plurality of engines, thereby allowing to distribute objects between the engines to horizontally increase the speed of the migration.

5. The system according to claim 4, wherein the management module selects a number of the migration slots based on formula I:
N≥K
where N is a number of the migration slots and K is a number of the engines of plurality of engines.

6. The system according to claim 4, wherein the slotter determines the migration slot based on formula II:
hash(object_key)% N
wherein hash is a hash function, % is modulo operation that returns the reminder of a division and object_key is a unique object identifier.

7. The system according to claim 4, wherein the slotter determines the migration slot based on formula III:
hash (key and seed)% slot_base==slot,
wherein hash is a hash function, % is modulo operation that returns the reminder of a division, slot_base is the selected number of the migration slots (N), ==denotes equality relation, and slot is an integer number from 0 to N−1 that identifies the migration slot N.

8. The system according to claim 4 further comprising a prober configured to verify each object individually using an object key when the comparator cannot compare the object page by page.

9. A computer-implemented method for migrating data from a first object storage service to a second object storage service, the method comprising:
receiving a migration request by a management module from a user;
identifying migration parameters based on data metrics collected from the first object storage service and the second object storage service;
determining a number of migration slots;
deploying a plurality of engines based on the migration parameters;
assigning a unique migration slot identifier to each engine of the plurality of engines;
independently listing, by each engine, objects stored in the first object storage service;
calculating, for each listed object, a hash value of an object key;
determining whether the object belongs to the assigned migration slot based on a modulo operation using the hash value and the number of migration slots;
providing tasks to the plurality of engines by the management module to migrate data from the first object storage service to the second object storage service; and
writing data objects in the second object storage service, and
wherein the plurality of engines migrate objects without requiring inter-engine communication during migration.

10. The method according to claim 9 further comprising:
receiving by a migration manager of the management module the tasks from tasks manger;
deploying the plurality of engines by an engine deployer based on the migration parameters;
receiving the migration status reports by a report processor from the plurality of engines and providing status reports to the task manager; and
retrieving tasks requests by a task describer from the plurality of engines, identifying tasks parameters and providing the task descriptions to each engine.

11. The method according to claim 10 further comprising:
listing objects by a first lister from the first object storage service and listing objects by a second lister from the second object storage service;
reading the objects by a migrator from the first object storage service and writing the objects in the second object storage service;
comparing by a comparator the objects from the first object storage service and the second object storage service to verify whether the object to be migrated to the second object storage service and feeding the lists of objects to be migrated to the migrator, wherein the comparator compares the objects page-by-page; and
assigning the migration slot to the engine on pseudo-random basis thereby allowing to distribute objects between the engines to horizontally increase the speed of the migration.

12. The method according to claim 11, wherein the management module selects a number of the migration slots based on formula I:
N≥K
where N is a number of the migration slots and K is a number of the engines of plurality of engines.

13. The system according to claim 11, wherein the slotter determines the migration slot based on formula II:
hash(object_key)% N
wherein hash is a hash function, % is modulo operation that returns the reminder of a division and object_key is a unique object identifier.

14. The method according to claim 11, wherein the slotter determines the migration slot based on formula II:
hash(key and seed)% slot_base==slot,
wherein hash is a hash function, key is an object key, seed is the seed value assigned to the migration, % is modulo operation that returns the reminder of a division, slot_base is the selected number of the migration slots (N), ==denotes equality relation, and slot is an integer number from 0 to N−1 that identifies the migration slot N.

15. The method according to claim 9, wherein the first object storage service and/or the second object storage service are cloud-native object storage services.

16. The method according to claim 11 further comprising verifying each object individually by a prober using an object key.

17. A computer-implement system for migrating object data from a source object storage to a destination object storage, the system comprising:
a memory; and
one or more processors to execute computer-readable instructions stored in the memory to perform a method comprising:
receiving a migration request by a management module from a user;
identifying migration parameters based on data metrics collected from the source object storage and the destination object storage;
determining a number of migration slots;
deploying a plurality of engines based on the migration parameters;
assigning a unique migration slot identifier to each engine of the plurality of engines;
receiving by a migration manager of the management module the tasks from tasks manger;
and assigning the migration slot to each engine of the plurality of engines;
receiving the migration status reports by a report processor from the plurality of engines and providing status reports to the task manager;
receiving tasks requests by a task describer from the plurality of engines, identifying tasks parameters and providing the tasks descriptions to each engines;
listing objects by a first lister from the first object storage service and listing objects by a second lister from the second object storage service;
reading the objects by a migrator from the source object storage and writing the objects in the destination object storage;
comparing by a comparator the objects from the source object storage and the objects in the destination object storage to verify whether the object to be migrated to the destination object storage and feeding the lists of objects to be migrated to the migrator, wherein the comparator compares the objects page-by-page; and
writing data objects in the destination object storage,
wherein migration objects are distributed pseudo-randomly across the plurality of engines without requiring communication between the plurality of engines during migration.

18. The method according to claim 17, wherein the management module selects a number of the migration slots based on formula I:
N≥K
where N is a number of the migration slots and K is a number of the engines of plurality of engines.

19. The method according to claim 17, wherein the slotter determines the migration slot based on formula II:
hash(key and seed)% slot_base==slot,
wherein hash is a hash function, key is an object key, seed is unique value selected for the migration by the management server, % is modulo operation that returns the reminder of a division, slot_base is the selected number of the migration slots (N), ==denotes equality relation, and slot is an integer number from 0 to N−1 that identifies the migration slot N.

20. A computer-implemented system for storing data in multiple object storages simultaneously, the system comprising:
a frontend abstraction configured to receive object-storage API requests from a client application, and translate the cloud specific requests to cloud-agnostic operations and translate responses associated with the cloud-agnostic operations into responses compatible with the object-storage API;
a multi-cloud proxy configured to receive the cloud-agnostic operations and process the cloud-agnostic operations to the multiple object storages by generating corresponding cloud-specific operations for each of a plurality of object storages, transmitting the cloud-specific operations to the plurality of object storages, and aggregating responses received from the plurality of object storages;
a continuation token combiner/parser configured to determine a unitary continuation token by combining individual continuation tokens received from at least two object storages, wherein each individual continuation token is determined based on an individual cloud identification, a cloud list page offset and a cloud continuation token, wherein the continuation token combiner/parser is further configured to parse the unitary continuation token to recover the continuation token associated with each object storage;
a multipart-upload identifier combiner/parser configured to generate a combined multipart-upload identifier from a plurality of storage-specific multipart-upload identifiers received from the plurality of object storages and parse the combined multipart-upload identifier to recover the storage-specific multipart-upload identifier associated with each object storage; and and
a version identifier combiner/parser configured to generate a combined version identifier from a plurality of storage-specific version identifiers received from the plurality of object storages and parse the combined version identifier to recover the storage-specific version identifier associated with each object storage,
wherein the frontend abstraction, the multi-cloud proxy, the continuation token combiner/parser, the multipart-upload identifier combiner/parser, and the version identifier combiner/parser collectively provide a cloud-specific object-storage interface that enables a client application designed for a single object-storage service to simultaneously access and store data across the plurality of cloud-agnostic object storages.
